(19) United States
(12) Patent Application Publication
(10) Pub. No.: US 2007/0182219 A1
(43) Pub. Date: Aug. 9, 2007

(54) Sunroof apparatus

(75) Inventors: Keiji Mori, Kariya-shi (JP); Youji Nagashima, Kariya-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: AISIN SEIKI KABUSHIKI KAISHA

(21) Appl. No.: 11/702,134

(22) Filed: Feb. 5, 2007

(30) Foreign Application Priority Data
Feb. 7, 2006 (JP) 2006-029837

(51) Int. Cl. B60J 7/057

(52) U.S. Cl. 296/223

(57) ABSTRACT

A sunroof apparatus for use in an automotive vehicle having a roof with an opening portion includes a movable panel, a supporting mechanism supporting the movable panel, an actuating device generating an actuating force for actuating the movable panel, a transmitting mechanism transmitting the actuating force, the transmitting mechanism having a rack belt made of resin and engaging with an actuating gear of the actuating device and a guiding member guiding the rack belt so as to be slidable, wherein the rack belt includes a plurality of longitudinally disposed and alternately spaced rack teeth and grooves, each of the grooves being provided with a protruding portion bridging two adjacent rack teeth at a mid portion of each groove, and a core wire embedded within the protruding portion of the rack belt so as to extend in a longitudinal direction of the rack belt.

### CROSS REFERENCE TO RELATED APPLICATIONS

This application is based on and claims priority under 35 U.S.C. § 119 to Japanese Patent Application 2006-029837, filed on Feb. 7, 2006, the entire content of which is incorporated herein by reference.

### FIELD OF THE INVENTION

The present invention relates to a sunroof apparatus. Specifically, the present invention relates to a configuration of a rack belt serving as means for transmitting an actuating force.

### BACKGROUND

A known sunroof apparatus, which actuates a movable panel so that an opening portion provided at a roof of a vehicle is opened/closed, includes an actuating device and a transmitting mechanism for transmitting an actuating force generated by the actuating device to a supporting mechanism of the movable panel.

More specifically, a sunroof apparatus disclosed in JP2001-130261A includes a geared cable used as the transmitting mechanism. The geared cable includes a cable portion and a gear portion, both of which are made of metal. The gear portion is provided continuously on the outer peripheral surface of the geared cable so as to extend spirally in a longitudinal direction thereof. The geared cable is guided by and within a metal guide having a circular cross section.

Further, another transmitting mechanism, for example, a roof apparatus disclosed in JP2002-154328A includes a rack belt instead of the geared cable. Such rack belt is made of resin in order to achieve weight saving and quietness in its actuation.

The geared cable disclosed in JP2001-130261A is flexible in any directions and has a tensile strength. The geared cable further includes strength at the gear portion thereof. Therefore, such geared cable has high endurances and is easy to attach to the sunroof apparatus.

On the other hand, the transmitting mechanism using a rack belt made of resin and disclosed in JP2002-154328A is lighter than the geared cable. Further, by use of such transmitting mechanism, quietness in its actuation can be obtained. In actual usage, in order to obtain a high tensile strength, a reinforcement member, such as a wire made of steel, may be embedded within the rack belt. However, because of such wire serving as a reinforcement member, it may be difficult to bend the rack belt depending on the position of the wire in the rack belt. Further, the rack belt is attached to the sunroof apparatus in a manner where it is slidably housed within the guide. In this configuration, because of the flexibility of the rack belt, frictional resistance occurring between the rack belt and the guide at a position where the guiding member together with the rack belt is bent may be increased, as a result, transmitting efficiency may be reduced.

For example, as illustrated in FIG. 2, a guiding member 28a, extending leftward from a central portion facing forward, crosses over a guiding member 27b at a position A, and then the guiding member 28a is bent upward. Further, at the point B where each guiding member extending in a front-rear direction toward the side of the guiding rail from the side of the housing 16, which is extending in a horizontal direction, the each guiding member is bended in a horizontal direction.

A need thus exists to provide a rack belt made of resin, which obtains a required strength so as to be capable of being a transmitting mechanism and is flexible in an upward and downward direction and a horizontal direction without increasing friction resistance.

### SUMMARY OF THE INVENTION

According to an aspect of the present invention, a sunroof apparatus for use in an automotive vehicle having a roof with an opening portion includes a movable panel opening and closing the opening portion formed on the roof of the automotive vehicle, a supporting mechanism supporting the movable panel movably relative to the roof, an actuating device generating an actuating force for actuating the movable panel, a transmitting mechanism transmitting the actuating force generated by the actuating device, the transmitting mechanism having a rack belt made of resin and engaging with an actuating gear of the actuating device and a guiding member guiding the rack belt so as to be slidable, wherein the rack belt includes a plurality of longitudinally disposed and alternately spaced rack teeth and grooves, each of the grooves being provided with a protruding portion bridging two adjacent rack teeth at a mid portion of each groove, and a core wire embedded within the protruding portion of the rack belt so as to extend in a longitudinal direction of the rack belt.

### BRIEF DESCRIPTION OF THE DRAWINGS

The foregoing and additional features and characteristics of the present invention will become more apparent from the following detailed description considered with reference to the accompanying drawings, wherein:

FIG. 1 illustrates a flat view indicating a sunroof apparatus of the present invention attached to a roof of a vehicle;

FIG. 2 illustrates an exploded perspective view indicating a front portion of the sunroof apparatus;

FIG. 3 illustrates an exploded perspective view indicating a supporting mechanism of the sunroof apparatus;

FIG. 4 illustrates an oblique perspective view indicating a state in which an actuating device is attached to the sunroof apparatus according to a first embodiment of the present invention;

FIG. 5 illustrates a cross sectional view indicating the actuating device the sunroof apparatus according to the first embodiment of the present invention;

FIG. 6 illustrates an oblique perspective view indicating a meshing state between rack belts and an actuating gear according to the first embodiment of the present invention;

FIG. 7 illustrates a cross sectional view of the transmitting mechanism along a VII-VII line in FIG. 2 according to the first embodiment of the present invention; and

FIG. 8 illustrates a cross sectional view indicating a transmitting mechanism of a sunroof apparatus according to a second embodiment of the present invention.

### DETAILED DESCRIPTION

A first embodiment of a sunroof apparatus 10 related to the present invention will be explained in accordance with the attached drawings.

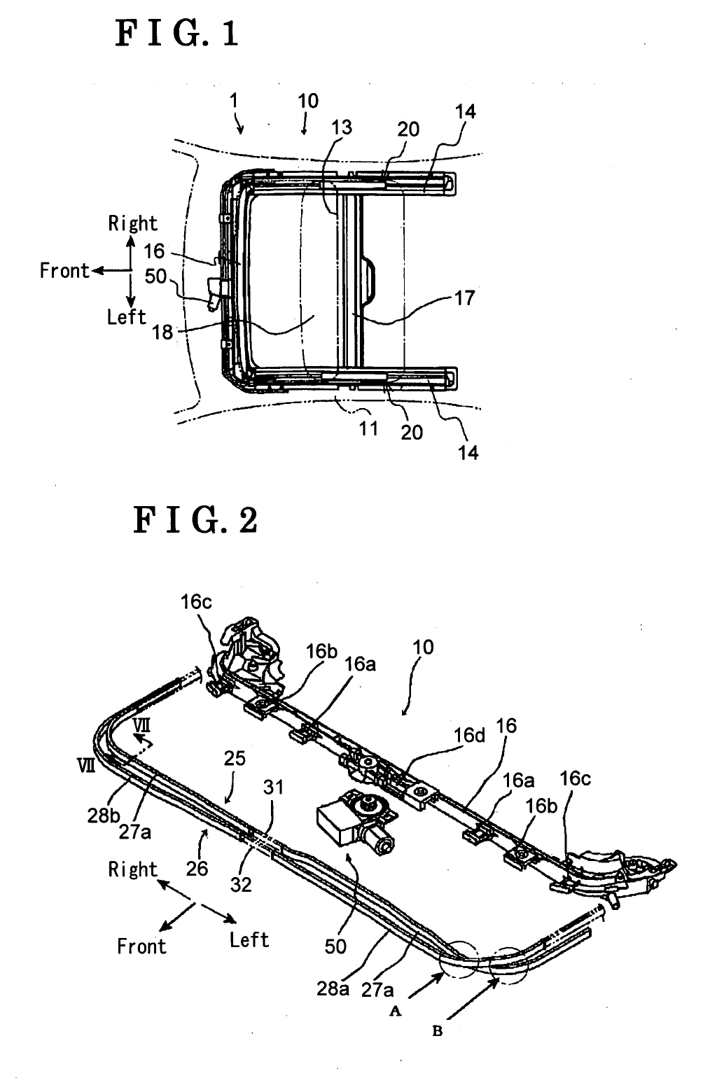

FIG. 1 illustrates a top view indicating the sunroof apparatus 10 attached to a roof 11 of a vehicle 1. FIG. 2 illustrates an exploded perspective view indicating a front portion of the sunroof apparatus 10.

Each direction indicated by arrows in the drawings represents a front direction, a left direction and a right direction relative to the vehicle 1. Because the sunroof apparatus 10 basically has a symmetric structure in a right-left direction of the vehicle 1, identical numerals are used in each right and left side of the sunroof apparatus 10, and different numbers are used only when there is a need to explain a difference in the configurations between the left side and the right side.

An opening portion 13 indicated by a chain double-dashed line in FIG. 1 is provided on the roof 11 of the vehicle 1. A pair of guiding rails 14 is provided at the opening portion 13, specifically, one guiding rail 14 (right guiding rail 14) is provided at the right edge of the opening portion 13, and the other guiding rail 14 (left guiding rail 14) is provided at the left edge of the opening portion 13, and each of them is provided so as to extend in a front-rear direction of the vehicle 1. Further, a housing 16 is provided along a front edge of the opening portion 13 so as to extend in a right-left direction of the vehicle 1, and a right end of the housing 16 is connected to a front end of the right guiding rail 14, and a left end of the housing 16 is connected to a front end of the left guiding rail 14.

The sunroof apparatus 10 is fixed to an under surface of the roof 11 by means of each guiding rail 14 and the housing 16. Further, the right guiding rail 14 is connected to the left guiding rail 14 by means of a supporting member 17 at a rearward portion of the sunroof apparatus 10 relative to a rear end of the opening portion 13. Therefore, as illustrated in FIG. 1, the sunroof apparatus 10 is also fixed to the under surface of the roof 11 by means of the supporting member 17.

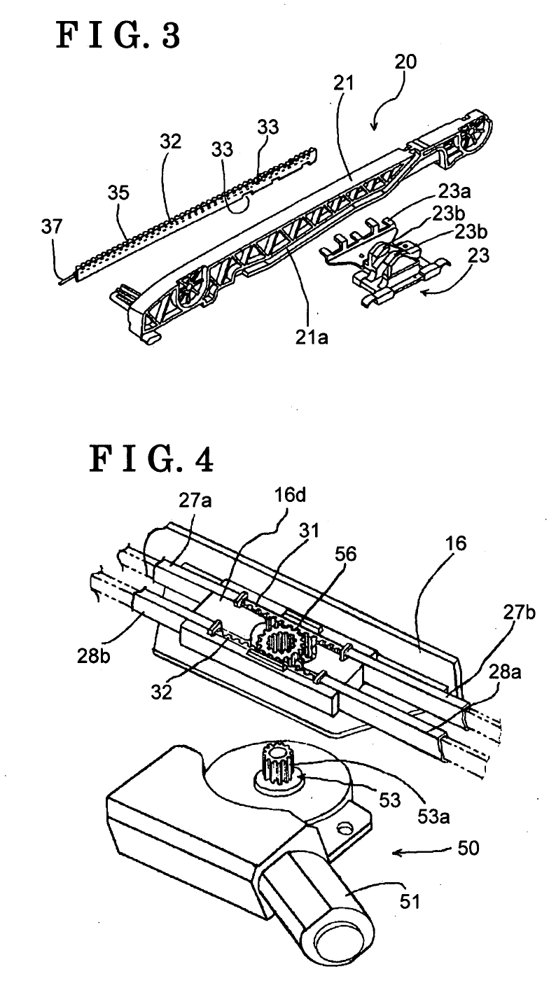

At each guiding rail 14, a supporting mechanism 20 for supporting the movable panel 18 from below thereof is attached. As illustrated in an exploded perspective view in FIG. 3, the supporting mechanism 20 includes a link member 21 and a shoe member 23. Each of the link member 21 and the shoe member 23 is supported by each guiding rail 14 so as to be slidable in a front-rear direction of the vehicle 1. Further, a pair of projecting portions 23b is formed at the shoe member 23 so as to be engageable with a pair of guiding grooves 21a formed at the link member 21. In FIG. 3, only one guiding groove 21a is illustrated. Because the projecting portions 23b are positioned relative to the guiding groove 21a in this manner, when the shoe member 23 is positioned at a predetermined position relative to the guiding rail 14, the movement of the link member 21 in a front-rear direction and a tilt of the link member 21 in an upper and lower direction are regulated, and further, the movable panel 18 fixed to the link member 21 is moved in a front-rear direction or tilted, so as to close and open the opening portion 13.

Furthermore, as illustrated in FIG. 3, plural detent portions 23a are formed at the shoe member 23. At the left side of the vehicle, a rack belt 32 is attached to the left guiding rail 14 so as to be movable in a front-rear direction. The shoe member 23 is connected to the rack belt 32 in a manner where the detent portions 23a of the shoe member 23 fit plural recessed portions 33 formed on upper and lower surfaces of the rack belt 32 at a rear end in a longitudinal direction thereof. On the other hand, at the right side of the vehicle, a rack belt 31 is attached to the right guiding rail 14 so as to be movable in a front-rear direction. The shoe member 23 is connected to the rack belt 31 in a manner where the detent portions 23a of the shoe member 23 fit plural recessed portions 33 formed on upper and lower surfaces of the rack belt 31 at a rear end in a longitudinal direction thereof. The transmitting mechanism 26 is comprised of the rack belt 32, guiding members 28a and 28b, and the transmitting mechanism 25 is comprised of the rack belt 31, guiding members 27a and 27b. Each guiding member will be described in detail below.

As illustrated in FIG. 2 and FIG. 4, at a front end of the right guiding rail 14, the guiding member 27a is connected at one end thereof. The guiding member 27a is bent so as to extend in a width direction of the vehicle along the housing 16, and then the guiding member 27a is attached to a right half portion of the housing 16 by means of engaging portions 16a, 16b and 16c, which are integrally formed at the right half portion of the housing 16. As illustrated in FIG. 4, a supporting base portion 16d, to which an actuating device 50 described later is attached, is formed at the housing 16, and the other end of the guiding member 27a is attached to a right portion of the supporting base portion 16d. The guiding member 27b is attached to a left portion of the supporting base portion 16d in a manner where one end of the guiding member 27b faces the other end of the guiding member 27a attached to the right portion of the supporting base portion 16d. In the same manner as the right half portion of the housing 16, the guiding member 27b is attached to a left half portion of the housing 16 by means of engaging portions 16a, 16b and 16c, which are formed at the left half portion of the housing 16. Further, the other end of the guiding member 27b is bent so as to correspond a side surface of the left guiding rail 14 and engaged therewith so as not to be affected by vibrations and the like.

The right rack belt 31 extends from the right shoe member 23 forward within the right guiding rails 14, and penetrates through the guiding member 27a. Further, the right rack belt 31 penetrates through the guiding member 27b and attached to the left guide rail 14. The length of the guiding member 27b is set in a manner where, when the shoe member 23 is moved foremost, the end of the rack belt 31 is not exposed to outside of the other end of guiding member 27b.

In the same manner as the right rack belt 31, the left rack belt 31 extends from the left shoe member 23 and attached to the right guide rail 14. In this way, the transmitting mechanism 25 is comprised of a combination of the guiding member 27a and the guiding member 27b, the transmitting mechanism 26 is comprised of a combination of the guiding member 28a and the guiding member 28b.

A configuration of the actuating device 50 will be explained in accordance with FIGS. 4, 5 and 6.

As mentioned above, the actuating device 50 is attached to the supporting based portion 16d, which is formed at the housing 16 at a central portion in a right-left direction thereof. The actuating device 50 includes a motor 51 for providing actuating force, a wheel 52 and a drive shaft 53. The actuating force generated by the motor 51 is transmitted to the wheel 52 in order to rotate the drive shaft 53 of the drive shaft provided so as to be integral to the wheel 52. A serration 53a comprised of plural grooves is formed at an outer peripheral surface of the drive shaft 53, and an actuating gear 56 is attached to the drive shaft 53 so as to be rotated integrally therewith. Specifically, the actuating gear 56 has a hole 55 at which a female serration 55a to be meshed with the serration 53a is formed. Further, teeth 57 are formed at an outer peripheral surface of the actuating gear 56.

As illustrated in FIGS. 4, 5 and 6, each rack belt 31 and 32 has rack teeth 35 including rack grooves 35a, and the rack belts 31 and 32 are provided in a manner where the actuating gear 56 is sandwiched therebetween, and the teeth 57 of the actuating gear 56 meshes the rack teeth 35 of each rack belt 31 and 32. In this configuration, the rack belts 31 and 32 are simultaneously actuated. Thus, the teeth 57 of the actuating gear 56 meshes the rack teeth 35 of each rack belt 31 and 32 so that the actuating force is transmitted to each rack belt 31 and 32. In this configuration, because each rack belt 31 and 32 is moved by the rotation of the actuating gear 56, the shoe members 23 attached to the rack belt 31 and the shoe member 23 attached to the rack belt 32 are simultaneously moved in the same direction.

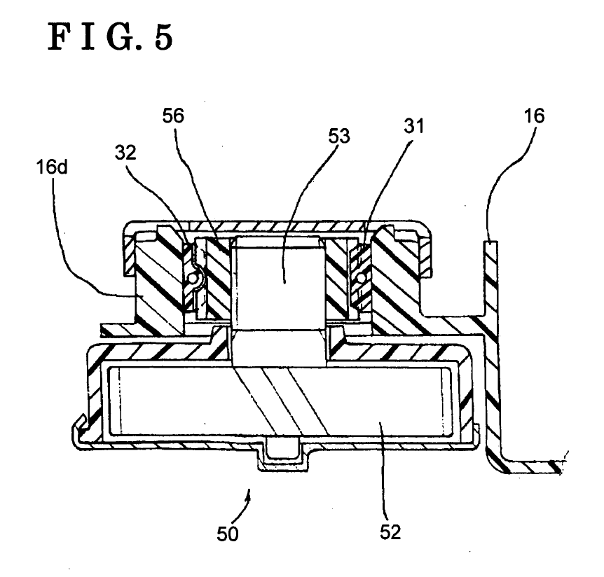

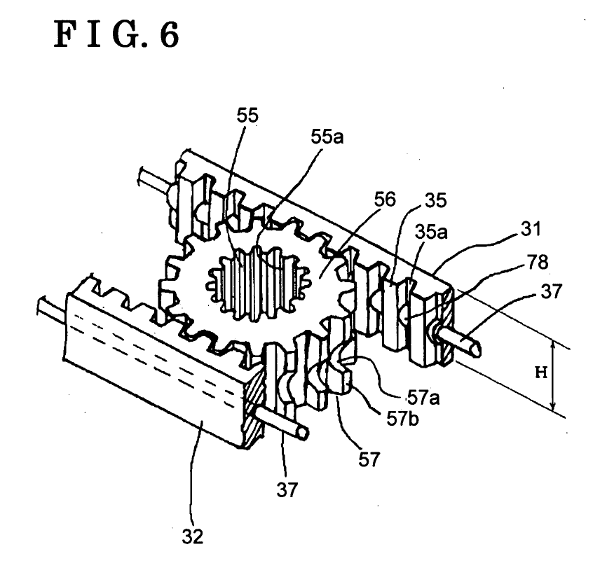

In accordance with FIGS. 5 and 6, a configuration of each rack belt 31 and 32 related to the present invention will be further explained.

In FIG. 6, a width of the rack teeth 35 of each rack belt 31 and 32 in a tooth trace direction is indicated by a width H. At a central portion of each rack belt 31 and 32 in the direction of the width H, a core wire 37 is embedded so as to extend in a longitudinal direction and within an entire length of each rack belt 31 and 32. When each rack belt 31 and 32, made of resin, is molded, the core wire 37 is embedded at a predetermined position by means of, for example, extrusion so as to be integral with each rack belt 31 and 32. In this method, production costs of the rack belt become less expensive. Further, in this embodiment, because a single core wire is embedded at the central portion of the width H of each rack belt 31 and 32, a flexibility of the resin rack belt 31 and 32 in any direction can be maintained at same level of a resin belt without a core wire.

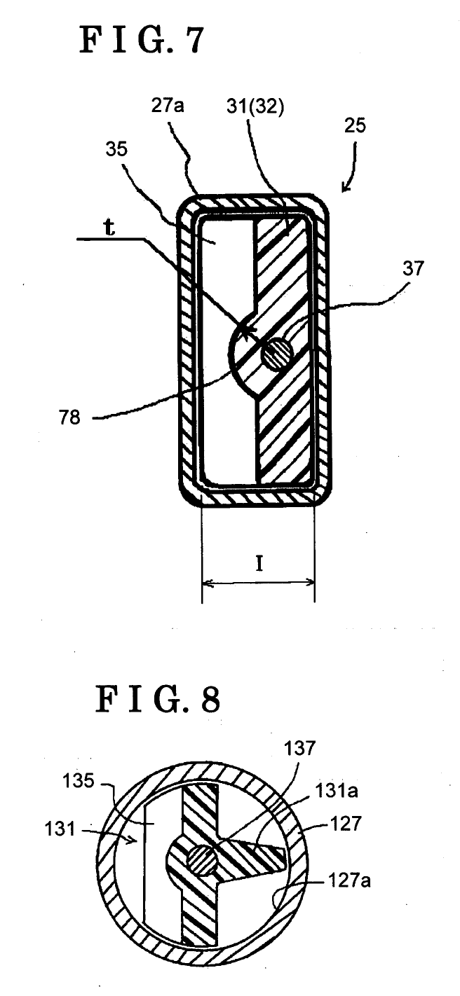

Further, as illustrated in FIG. 7, protruding portions 78 is formed at each rack belt 31 and 32. Specifically, each protruding portion 78 is formed in a manner where a thickness thereof relative to the core wire 37 in its cross section becomes a thickness “t” indicated in FIG. 7. Each protruding portion 78 is formed at the central portion of each rack groove 35a so as to bridge between one of the rack teeth 35 and the other of the rack teeth 35, which is formed next to the one of the rack teeth 35, as illustrated in FIG. 6. In this configuration, as illustrated in FIG. 7, a thickness “I” of each rack belt 31 and 32 is reduced as far as possible so that the costs thereof are reduced. Because the thickness “I” of each rack belt 31 and 32 is reduced, flexibility thereof in a horizontal direction is also obtained. Further, because the protruding portion 78 is formed and provided so as to bridge between one of the rack teeth 53 and the other of the rack teeth 53 at a central portion thereof as mention above, a strength of the rack teeth 35 can be enhanced, as a result, the size of each teeth of the rack teeth 53 can be reduced, and a meshing pitch between each rack belt 31 and 32 and the actuating gear 56 can be reduced. Thus, positional adjustment of the movable panel 18, in other words, installation adjustment of the movable panel 18 becomes easier.

Furthermore, on each of the teeth 57 of the actuating gear 56, a recessed portion 57a is formed as illustrated in FIG. 6. Thus, when the actuating gear 56 meshes each of rack belts 31 and 32, because the recessed portion 57a is formed at each of the teeth 57, the each of the teeth 57 does not interfere with the protruding portion 78 formed at each rack belt 31 and 32. In this configuration, the teeth 57 of the actuating gear 56 mesh the rack groove 35a at meshing portions 57b of the teeth 57 as illustrated in FIG. 6. In this embodiment, two meshing portions 57b are formed on each of the teeth 57a, and one meshing portion 57b is formed at the upper side relative to the recessed portion 57a, and the other meshing portion 57b is formed at the lower side relative to the recessed portion 57a as illustrated in FIG. 6. Because of the recessed portion 57a meshing the protruding portion 78, the actuating gear 56 can mesh each rack belt 31 and 32 precisely.

In this configuration, according to the sunroof apparatus 10 of the present invention, as illustrated in FIG. 2, the guiding member 28a extending leftward crosses with the guiding member 27b at a position A, and at this position, the guiding member 28a is bended upward. Further, at the point B where each guiding member 28a and 27b extending in a front-rear direction toward the side of the guiding rail 14 from the side of the housing 16, which is extending in a horizontal direction, the each guiding member is bended in a horizontal direction. In this configuration, because each rack belt 31 and 32 is flexible, actuation force can be effectively transmitted by means of each rack belt 31 and 32, without enhancing sliding resistance at the positions A and B.

A second embodiment related to the present invention will be explained in accordance with FIG. 8.

In the second embodiment, a guiding member 127 for guiding the rack belt 31 is made of a pipe including a hollow portion having a circular cross section. The rack belt 131 slides with contacting with an inner peripheral surface of the hollow portion of the guiding member 127 at three portions, each upper and lower surface of the rock teeth 135 and a contacting protruding portion 131a formed at a back surface of the rock teeth 135. A core wire 137 is embedded at a central portion of the rack belt 131. Specifically, the core wire 137 is embedded at the rack belt 131 at a position being identical with a center of the internal diameter of the guiding member 127. In the second embodiment, because of the existence of the contacting protruding portion 131a, stiffness in a vertical direction can be enhanced relative to the rack belt in the first embodiment. Further, when the guiding member 127 is made of an existing pipe material made of metal, an accurate internal diameter can be obtained, and the costs thereof can be reduced.

In the second embodiment, a guiding member 127 for guiding the rack belt 31 is made of a pipe including a hollow portion having a circular cross section. The rack belt 131 slides with contacting with an inner peripheral surface of the hollow portion of the guiding member 127 at three portions, each upper and lower surface of the rock teeth 135 and a contacting protruding portion 131a formed at a back surface of the rock teeth 135. A core wire 137 is embedded at a central portion of the rack belt 131. Specifically, the core wire 137 is embedded at the rack belt 131 at a position being identical with a center of the internal diameter of the guiding member 127. In the second embodiment, because of the existence of the contacting protruding portion 131a, stiffness in a vertical direction can be enhanced relative to the rack belt in the first embodiment. Further, when the guiding member 127 is made of an existing pipe material made of metal, an accurate internal diameter can be obtained, and the costs thereof can be reduced.

Thus, because the core wire is embedded in the rack belt in a manner where it extends in a longitudinal direction thereof, a required tensile strength of the rack belt for transmitting the actuating force is obtained. In this configuration, the core wire is penetrated through the protruding portions provided at the central portion in a tooth trace direction of each rack groove of the rack teeth. Thus, even when the rack belt is bent in a vertical or a horizontal direction, a tensile force or a compressive force applied to the core wire can be reduced, and a flexibility being approximately equal to that of a rack belt made of resin without a core wire is obtained. Further, because of this flexibility, resistance of the rack belt at a portion thereof at which it is bent in order to be attached to the sunroof apparatus can be reduced.

Further, strength of the rack teeth is enhanced because of the protruding portion formed at the rack groove provided at the rack teeth.

Such the guiding member may be made of an existing pipe material made of metal, an accurate internal diameter can be obtained, and the costs thereof can be reduced. Thus, the transmitting mechanism having such guiding member is easy to be attached to the sunroof apparatus, and its resistance can be reduced.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the sprit of the present invention. Accordingly, it is expressly intended that all such variations, changes and equivalents which fall within the spirit and scope of the present invention as defined in the claims, be embraced thereby.

1. A sunroof apparatus for use in an automotive vehicle having a roof with an opening portion, the sunroof apparatus comprising:
a movable panel opening and closing the opening portion formed on the roof of the automotive vehicle;
a supporting mechanism supporting the movable panel movably relative to the roof;
an actuating device generating an actuating force for actuating the movable panel;
a transmitting mechanism transmitting the actuating force generated by the actuating device;
the transmitting mechanism including:
a rack belt made of resin and engaging with an actuating gear of the actuating device; and
a guiding member guiding the rack belt so as to be slidable,
wherein the rack belt includes a plurality of longitudinally disposed and alternately spaced rack teeth and grooves, each of the grooves being provided with a protruding portion bridging two adjacent rack teeth at a mid portion of each groove, and a core wire embedded within the protruding portion of the rack belt so as to extend in a longitudinal direction of the rack belt.

2. The sunroof apparatus according to claim 1, wherein, the actuating gear includes teeth, and each tooth includes: a recessed portion formed at a central portion in a tooth trace direction thereof, and a meshing portion formed so as to abut on the recessed portion, and while the rack belt meshes the actuating gear, the protruding portions fit the recessed portions.

3. The sunroof apparatus according to claim 1, wherein the guiding member includes a hollow portion having a circular cross section, and the rack belt is provided within the hollow portion so as to be slidable and spaced at a predetermined distance from an inner peripheral surface of the hollow portion.

4. The sunroof apparatus according to claim 1, wherein the core wire is embedded in the rack belt when the rack belt made of resin is molded.

5. The sunroof apparatus according to claim 1, wherein the core wire is a single metal wire.
